(19) United States
(12) Patent Application Publication
(10) Pub. No.: US 2024/0000095 A1
(43) Pub. Date: Jan. 4, 2024

(54) FLAVORED OIL, FOOD COMPRISING FLAVORED OIL, AND METHOD FOR MANUFACTURING FLAVORED OIL

(71) Applicant: MIYOSHI OIL & FAT CO., LTD., Tokyo (JP)

(72) Inventors: Keisuke UOZUMI, Tokyo (JP); Yusuke TOMITA, Tokyo (JP); Akira OHTA, Tokyo (JP)

(73) Assignee: MIYOSHI OIL & FAT CO., LTD., Tokyo (JP)

(21) Appl. No.: 18/217,327

(22) Filed: Jun. 30, 2023

(30) Foreign Application Priority Data
Jul. 1, 2022 (JP) 2022-106838

(51) Int. Cl. A23D 7/005; A23L 27/26; A23L 27/10; A23L 33/145; A23L 33/15; A23L 33/105; A23L 33/18; A23D 7/04; A23J 3/22

(52) U.S. Cl. CPC A23D 7/0053; A23L 27/26; A23L 27/10; A23L 33/145; A23L 33/15; A23L 33/105; A23L 33/18; A23D 7/04; A23J 3/227

(57) ABSTRACT

The present disclosure provides a flavored oil and a food containing the flavored oil. The flavored oil according to the present disclosure contains: (A) one or more ingredients selected from yeast-derived substances and protein hydrolysates; and (B) a spice. The present disclosure also provides a method for manufacturing the flavored oil, said method comprising the steps of: A) adding the one or more ingredients selected from yeast-derived substances and protein hydrolysate, and the spice to the oil or fat to prepare a mixture; B) heating the mixture prepared in step A) whilst stirring the same; and C) cooling the product obtained in step B) to room temperature.

### CROSS REFERENCE TO RELATED APPLICATIONS

This application claims priority of Japanese Patent Application No. 2022-106838 filed on Jul. 1, 2022, the entirety of which are incorporated by reference herein.

### TECHNICAL FIELD

This disclosure relates generally to a flavored oil, a food comprising the flavored oil and a method for manufacturing the flavored oil.

### BACKGROUND

In recent years, there has been growing global interest in developing truly sustainable food production systems to achieve the so-called “Sustainable Development Goals (or SDGs for short)” for which “alternative meats” or “cultured meats” have received particular attention. Recently, the markets for alternative meats and various seasoning products have continued to grow, where such alternative meats and various seasoning products are made from plant-based ingredients which accommodate a whole variety of lifestyles of, for example, flexitarians, vegetarians and vegans.

The vegan market is particularly fast-growing. Therefore, there is a strong demand for imparting a meaty flavor without using animal-based ingredients, and a seasoning product with a meaty flavor is expected to be in growing demand in the future because such a product is capable of imparting a flavor or a cooked taste to a food product.

A flavored oil is known as a condiment for enhancing the tastes of various food and beverage products including the above-mentioned meat substitutes. The “flavored oil” is also termed as flavoring oil, and a well-known example of which includes an oil to which a desired flavor of, for example, green onion or garlic is imparted.

As a technique for imparting a meaty flavor without using an animal-based ingredient such as animal meats, animal-based extracts, animal oils and fats, milk constituents and eggs, JP2016/502867 (A1) discloses a food product comprising a highly conjugated heterocyclic ring complexed to iron ion and one or more flavor precursor molecules of, for example, glucose. Further, WO2018/147326(A1) discloses a flavored oil and fat obtained by adding a yeast digest to an edible oil or fat, and heating the edible oil or fat with the yeast digest added thereto.

Unfortunately, JP2016/502867 (A1) has a drawback in that it is cumbersome to prepare the highly conjugated heterocyclic ring complexed to iron ion. Moreover, WO2018/147326(A1) has yet to achieve an impartment of a more realistic meaty flavor, i.e., a flavor having a meaty flavor and a cooked taste.

### SUMMARY

The present disclosure was made in view of the above circumstances, and a problem to be solved by the present disclosure is to provide a flavored oil that imparts a meaty flavor and cooked taste.

### Means for Solving the Problem

The present inventors earnestly studied the above-mentioned problem, and have found out that the above-mentioned problem can be solved by adding: one or more ingredients selected from yeast-derived substances and protein hydrolysates; and a spice, which therefore led to the achievement of the present disclosure. Specifically, the present disclosure provides the matters as defined by the following clauses 1) to 17).
1) A flavored oil comprising:
   A) one or more ingredients selected from yeast-derived substances and protein hydrolysates;
   B) a spice; and
   C) an oil or fat.
2) The flavored oil according to clause 1), wherein the flavored oil comprises both of the yeast-derived substance and the protein hydrolysate.
3) The flavored oil according to clause 2), wherein a weight ratio of the yeast-derived substance to the protein hydrolysate is 0.01 or more and 10 or less.
4) The flavored oil according to clause 3), wherein the ratio of the yeast-derived substance to the protein hydrolysate is 0.3 or more and 2 or less.
5) The flavored oil according to clause 1), wherein the flavored oil comprises a yeast extract of the yeasts selected from baker's yeasts, beer yeasts, sake yeasts, wine yeasts, soy sauce yeasts and torula yeast.
6) The flavored oil according to clause 5), wherein the yeast extract is of torula yeast.
7) The flavored oil according to clause 1), wherein the flavored oil further comprises vitamin B1.
8) The flavored oil according to clause 1), wherein the spice is derived from one or more plants selected from the species consisting of Myristicaceae and Myrtaceae.
9) The flavored oil according to clause 1), wherein the flavored oil further comprises a nut derivative.
10) The flavored oil according to clause 9), wherein an amount of the nut derivative is or more and 15 wt % or less based on the total weight of the flavored oil.
11) A food or drink product comprising the flavored oil according to clause 1).
12) A method for manufacturing the flavored oil according to clause 1), comprising the steps of:
   A) adding the one or more ingredients selected from yeast-derived substances and protein hydrolysate, and the spice to the oil or fat to prepare a mixture;
   B) heating the mixture prepared in step A) whilst stirring the same; and
   C) cooling the product obtained in step B) to room temperature.
13) The method according to clause 12), further comprising a step of D) filtrating the product obtained after step B) to remove a solid residue(s) and water.
14) The method according to clause 12), further comprising a step of E) adding vitamin B1.
15) The method according to clause 14), wherein, in step E), the added amount of vitamin B1 is 0.0010 wt % or more and 5.0 wt % or less based on the total weight of the flavored oil.
16) The method according to clause 12), wherein the method comprises in step A) the steps of:
   A1) allowing an oil-soluble ingredient(s) of the mixture to be added to the oil or fat to obtain an oil phase portion;
   A2) allowing a water-soluble/oil-insoluble ingredient(s) of the mixture to be added to water to obtain an aqueous phase portion; and
   A3) mixing and stirring the oil phase portion and the aqueous phase portion.
17) The method according to clause 13), wherein the method comprises in step A) the steps of:
   A1) allowing an oil-soluble ingredient(s) of the mixture to be added to the oil or fat to obtain an oil phase portion;
   A2) allowing a water-soluble/oil-insoluble ingredient(s) of the mixture to be added to water to obtain an aqueous phase portion; and
   A3) mixing and stirring the oil phase portion and the aqueous phase portion.

### Effects of the Invention

The present disclosure provides a flavored oil that imparts a meaty flavor and cooked taste.

### DETAILED DESCRIPTION

Specific embodiments of the disclosure are described below, but the disclosure is not limited to this.

The term “meaty flavor” as used herein refers to, for example, a flavor that reminds oneself of meat, particularly of cooked meat.

The term “cooked taste” as used herein refers to, for example, a flavor that reminds oneself of a hamburger patty of cooked beef.

The flavored oil of the present disclosure may have a favorable roasted flavor. The term “roast” or “roasted” as used herein refers to, for example, a flavor that reminds oneself of the one brought by searing meat by direct flame.

The flavored oil of the present disclosure may also have a favorable robustness. The term “robustness” as used herein refers to, for example, a flavor that is rich and thick.

The flavored oil of the present disclosure may also have a favorable sweetness. The term “sweetness” as used herein refers to a sweet flavor that resembles the so-called “WAGYU-kou”—a sweet aroma specific to the Japanese Wagyu beef fat.

The flavored oil according to the present disclosure may also have a technical advantage of masking a green-beany odor. The term “green-beany odor” as used herein refers to an unpleasant odor that is innate to the plant proteins such as proteins of soy or to a strange flavor such as an odor peculiar to the soy beans.

It is to be understood in the present disclosure that the amount of a component which is referred to in the context of the total weight of the flavored oil generally referrers to an amount of the component itself having been added thereto in the process of manufacturing the flavored oil. This terminology is also used when referring to a ratio between a plurality of such components. The component may partially transfer to a flavored oil after being added thereto in the process of manufacturing the flavored oil to be, for example, an extract. In such case, a component that remains in the flavored oil after removing the solid residue of the component is also regarded as such component. The components as described herein include component (A), component (B) and a further component to be added in the process of manufacturing the flavored oil.

The flavored oil of the present disclosure may be made by adding: (A) one or more ingredients selected from yeast-derived substances and protein hydrolysates; and (B) a spice.

### <Component (A)>

Examples of the yeast-derived substance to be used as a component (A) in the present disclosure include, for example, yeast fungi themselves (including live yeasts and dried yeasts), yeast extracts and yeast digests (such as yeast autolysates and yeast enzyme degradation products). They may be used alone or in combination with two or more species. There may be used yeast-derived substances that are publicly known and commercially available. Among them, yeast extracts are particularly preferred in terms of imparting a favorable meaty flavor. Examples of such yeasts include baker's yeasts, beer yeasts, sake yeasts, wine yeasts, soy sauce yeasts and torula yeast. Among these, torula yeast is particularly preferred from the viewpoint of imparting a favorable meaty flavor.

The “yeast-derived substance” as used herein as a component (A) encompasses a yeast-derived substance itself having been added to an oil or fat. The “yeast-derived substance” also encompasses a component having been transferred to the oil or fat in a form of, e.g., an extract of the yeast-derived substance which is obtained by, in particular, heating to promote the transfer of the extract, after adding the yeast-derived substance itself to the fat or oil in a manufacturing process of the flavored oil. For example, the yeast-derived substance extract may be a component having been remained in the oil after performing the processes of: adding a yeast-derived substance itself to the oil or fat, heating the same, and then removing the solid residue of the yeast-derived substance from the oil.

In terms of sufficiently imparting a favorable meaty flavor and cooked taste to the flavored oil, an added amount of the yeast-derived substance may preferably be 0.010 wt % or more, more preferably 0.050 wt % or more, even more preferably 0.10 wt % or more and still more preferably 0.50 wt % or more based on the total weight of the flavored oil. No upper limit is particularly set for the added amount of the yeast-derived substance, but in terms of balancing the potency and cost of the flavored oil, an added amount of the yeast-derived substance may preferably be 10 wt % or less, more preferably 8.0 wt % or less, even more preferably 6.0 wt % or less and still more preferably 5.0 wt % or less based on the total weight of the flavored oil. The term “added amount” as used herein refers to an amount of yeast-derived substance itself having been added thereto in the process of manufacturing the flavored oil.

The term “protein hydrolysate” as used herein as a component (A) refers to a hydrolysate obtained by decomposing protein by using a manufacturing process such as hydrochloric acid decomposition, enzymatic decomposition and hot water extraction. Although the ingredients of proteins include ingredients which are originated from animals (milk, gelatin, etc.) or plants (wheat, soybeans, corn, etc.), in terms of imparting thereto a meaty flavor and cooked taste without using an animal-based ingredient, it is preferred that the ingredients of proteins be originated from plants. A corn-based ingredient is particularly preferred in terms of imparting a favorable meaty flavor. The protein hydrolysates may be used alone or in combination with two or more species.

The “protein hydrolysate” as used herein as a component (A) encompasses a protein hydrolysate itself having been added to an oil or fat. The “protein hydrolysate” also encompasses a component having been transferred to the oil or fat in a form of, e.g., an extract of the protein hydrolysate which is obtained by, in particular, heating to promote the transfer of the extract, after adding the protein hydrolysate itself to the fat or oil in a manufacturing process of the flavored oil. For example, the protein hydrolysate extract may be a component having been remained in the oil after performing the processes of: adding a protein hydrolysate itself to the oil or fat, heating the same, and then removing the solid residue of the protein hydrolysate from the oil.

In terms of sufficiently imparting a meaty flavor and a cooked taste to the flavored oil, an added amount of the protein hydrolysate may preferably be 0.010 wt % or more, more preferably 0.050 wt % or more, even more preferably 0.10 wt % or more and still more preferably 0.50 wt % or more, based on the total weight of the flavored oil. No upper limit is particularly set for the added amount of the protein hydrolysate, but in terms of balancing the potency and cost of the flavored oil, an added amount of the protein hydrolysate may preferably be 10 wt % or less, more preferably 8.0 wt % or less, even more preferably 6.0 wt % or less and still more preferably 5.0 wt % or less based on the total weight of the flavored oil. The term “added amount” as used herein refers to an amount of protein hydrolysate itself having been added thereto in the process of manufacturing the flavored oil.

In terms of sufficiently imparting a meaty flavor and a cooked taste to the flavored oil, it is preferred for the flavored oil of the present disclosure to use both of the yeast-derived substance and the protein hydrolysate in combination rather than the case where only one of them is used alone. When both of the yeast-derived substance and the protein hydrolysate are used in combination, it is preferred that a weight ratio of the yeast-derived substance to the protein hydrolysate (yeast-derived substance/protein hydrolysate) be 0.01 or more, even more preferably 0.05 or more, still more preferably 0.1 or more, particularly more preferably 0.3 or more. Although no upper limit is particularly set for the weight ratio of the yeast-derived substance to the protein hydrolysate, it is preferred that the weight ratio be 10 or less, more preferably 8 or less, still more preferably 6 or less, even more preferably 4 or less, and particularly more preferably 2 or less.

### <Component (B)>

The “spice” as used herein as a component (B) encompasses a spice itself having been added to an oil or fat. The “spice” also encompasses a component having been transferred to the oil or fat in a form of, e.g., an extract of the spice which is obtained by, in particular, heating to promote the transfer of the extract, after adding the spice itself to the fat or oil in a manufacturing process of the flavored oil. For example, the spice extract may be a component having been remained in the oil after performing the processes of: adding a spice itself to the oil or fat, heating the same, and then removing the solid residue of the spice from the oil. Examples of the spice to be used as a component (B) in the present disclosure include, for example, spices derived from plants including: Lamiaceae such as mint, basil, marjoram, oregano, sage, thyme, rosemary, labiatae, savory, lemon balm and lavender; Solanaceae such as chili peppers and bell peppers; Pedaliaceae such as sesame; Asteraceae such as chamomile, tarragon and mugwort; Piperaceae such as pepper and Piper longum (long pepper); Myristicaceae such as nutmeg and mace; Lauraceae such as laurel and cinnamon; Illiciaceae such as star anise; Brassicaceae such as mustard, wasabi, horseradish and arugula (rocket salad); Fabaceae such as fenugreek and kanzo (licorice); and Rutaceae such as zanthoxyli fructus, huajiao, Citrus reticulata peel, yuzu (yuzu citrus), cafe lime, curry leaf; Myrtaceae such as clove and allspice; Apiaceae such as dill, celery, caraway, coriander (cilantro), cumin, fennel, parsley, anise, ajowan and honewort; Liliaceae such as garlic, onion, shallot, green onion, chinese leek, and chives (ciboulette); Iridaceae such as saffron; Zingiberaceae such as ginger, turmeric, cardamom and Zingiber mioga; Orchidaceae such as vanilla; and Gramineae such as lemongrass. The above-listed examples may be used in forms of stems, leaves, flowers or other parts of these plants, or processed products thereof. They may be used alone or in combination with two or more species. Among them, in terms of sufficiently imparting a meaty flavor, Myristicaceae, Myrtaceae, Apiaceae and Liliaceae are preferred, among which Myristicaceae and Myrtaceae are more preferred. Nutmeg is particularly preferred among them in terms of sufficiently imparting a cooked taste and roasted flavor.

In terms of sufficiently imparting a favorable meaty flavor to the flavored oil, an added amount of the spice may preferably be 0.0010 wt % or more, more preferably or more, even more preferably 0.050 wt % or more, and particularly preferably or more based on the total weight of the flavored oil. No upper limit is particularly set for the added amount of the spices, but in terms of contribution to the flavor of the flavored oil, an added amount of the spice may preferably be 5 wt % or less, more preferably 3.0 wt % or less, and even more preferably 1.0 wt % or less. The term “added amount” as used herein refers to an amount of spice itself having been added thereto in the process of manufacturing the flavored oil.

### <Oils and Fats>

An oil or fat is an object to which a flavor is to be imparted as a flavored oil, and is a basic ingredient of the flavored oil. An edible oil or fat is normally used for the oil or fat. Examples of the oils and fats include vegetable oils, animal oils and fats, synthetic oils and fats, and processed oils and fats. They may be used alone or as a blended oil in combination with two or more types of oils and fats.

The present disclosure is advantageous in that it imparts a meaty flavor and cooked taste without containing any animal-based ingredient. Accordingly, the embodiments of the present disclosure allow a food product to have a favorable meaty flavor and a cooked taste even when only oils or fats other than the animal-based oils and fats is used as oils or fats (preferably a case where only vegetable oils and/or processing oils of vegetable oils are used).

Examples of the vegetable oils include, a rapeseed oil, coconut oil, palm oil, sunflower oil, soybean oil, corn oil, sesame oil, perilla oil, flaxseed oil, peanut oil, safflower oil, a high oleic safflower oil, a high oleic sunflower oil, cottonseed oil, grape seed oil, macadamia nut oil, hazelnut oil, pumpkin seed oil, walnut oil, camellia oil, tea seed oil, perilla oil, borage oil, olive oil, rice bran oil, wheat germ oil, cocoa fat, palm kernel oil and an algae oil.

Examples of the animal oils and fats include a fish oil (an oil derived from tuna, mackerel, sardines, bonito, herring, etc.), pork fat (lard), beef fat (tallow), milkfat, sheep fat and chicken oil.

Examples of the synthetic oils and fats include a medium chain triglyceride and diacylglycerol.

The processed oils and fats may be oils and fats where any of the above-listed oils and fats are subjected to desired processing. Examples of such processing include fractionation (such as fractionated milkfat low melting point portion and palm super olein), hardening and ester exchange reaction. The oils and fats may be subjected to one or more processing.

The melting points of the oils and fats, with respect to the oils and fats themselves when used alone or to the whole oils and fats when used in combination as a blended oil and fat, are preferably 50° C. or less for imparting sufficient flavor to an oil or fat. Among them, an oil or fat in liquid form at room temperature (25° C.) may preferably be used.

In terms of providing sufficient fluidly to the flavored oil according to the present disclosure, the content of an oil-soluble ingredient may be, although not particularly limited, preferably 50 wt % or more, more preferably 60 wt % or more, and even more preferably 70 wt % or more based on the total weight of the flavored oil. The term “oil-soluble ingredient” as used herein refers to an oil or fat or to an ingredient soluble in the oil or fat.

### <Further Ingredient>

The flavored oil may contain, as a further ingredient, a food substance or additive which is publicly known and blended to, for example, a food or drink product as far as the further ingredient does not impede the technical advantages of the present disclosure. The further ingredient as used herein is not particularly limited and may contain an animal-based ingredient (e.g., meat. an ingredient originated from an animal meat, animal oil or fat, a milk constituent, egg, etc.). However, in spirit of the present disclosure which is advantageous for imparting a meaty flavor and a cooked taste without containing any animal-based ingredient, it is preferred in terms of adapting to the sustainable food production system that a lesser animal-based ingredient, preferably no animal-based ingredient, be contained therein.

It is preferred according to the present disclosure that the flavored oil further contains vitamin B1. Vitamin B1 is also referred to as thiamine, which is categorized as a hydrosoluble vitamin. Although vitamin B1 may be of any form, it is preferred that vitamin B1 be in the form of salt such as thiamine hydrochloride.

In terms of sufficiently imparting a meaty flavor and a cooked taste to the flavored oil, an added amount of vitamin B1 may preferably be 0.0010 wt % or more, more preferably or more, even more preferably 0.010 wt % or more, and particularly preferably or more based on the total weight of the flavored oil. No upper limit is particularly set for the added amount of vitamin B1, but in terms of balancing the potency and cost of the flavored oil, an added amount of vitamin B1 may preferably be 5.0 wt % or less, more preferably 3.0 wt % or less, and even more preferably 1.0 wt % or less, based on the total weight of the flavored oil.

It is preferred that the flavored oil according to the present disclosure contain a nut derivative. Examples of such nut derivative include nuts themselves and processed products of nuts. Examples of the nuts include, for example, hazelnuts, macadamia nuts, chestnuts, almond, walnuts, pecan nuts (nuts of Carya illinoensis), ginkgo nuts, coconuts, cashew, Brazil nuts, pistachio, pine nuts, sunflower seed, pumpkin seed, watermelon seed and sesame seed (sesame). Examples of the processed products of nuts include, for example, nut extracts (oils, extracts) and powdered products thereof.

In terms of sufficiently imparting a robustness and sweetness to the flavored oil, an added amount of the nut derivative may preferably be 0.010 wt % or more, more preferably or more, even more preferably 0.10 wt % or more, and particularly preferably or more based on the total weight of the flavored oil. Although no upper limit is particularly set for the added amount of the nut derivative, in terms of contribution to the flavor of flavored oil, an added amount of the nut derivative may preferably be 15 wt % or less, more preferably 10 wt % or less, even more preferably 8.0 wt % or less, and particularly more preferably 6.0 wt % or less, based on the total weight of the flavored oil.

It is preferred that the flavored oil according to the present disclosure contains a smoked flavoring. Examples of such smoked flavoring include smoked oils and smoked liquid.

When a smoked flavoring is added thereto, in terms of sufficiently imparting a meaty flavor, a cooked taste and a roasted flavor to the flavored oil, an added amount of the smoked flavoring may preferably be 0.010 wt % or more, more preferably 0.050 wt % or more, even more preferably 0.10 wt % or more, and particularly preferably 0.30 wt % or more based on the total weight of the flavored oil. No upper limit is particularly set for the added amount of the smoked flavoring, but in terms of contribution to the flavor of flavored oil, an added amount of the smoked flavoring may preferably be 10 wt % or less, more preferably 8.0 wt % or less, and even more preferably 6.0 wt % or less, based on the total weight of the flavored oil.

The flavored oil according to the present disclosure may further contain a carbohydrate. Examples of the carbohydrate include: sugars such as monosaccharides (such as glucose, fructose, galactose, mannose, xylose) and disaccharides (such as lactose (sugar of milk), sucrose, maltose, trehalose); oligosaccharides such as fructo-oligosaccharide, galacto-oligosaccharide (4′-Galactosyllactose), xylo-oligosaccharide, sugar beet oligosaccharides (raffinose), soybean oligosaccharides (raffinose, stachyose) and lactosucrose; polysaccharides such as dextrins (such as dextrin, maltodextrin, isomaltodextrin (branched maltodextrin), starch syrup, powdered starch syrup, cyclodextrins, branched cyclodextrins, roasted dextrins, polymer dextrins, indigestible dextrins), Inulins (such as Inulin, inulin degradation products and agave inulin), polysaccharide thickeners (such as LM pectin, HM pectin, pullulan, guar gum, guar gum degradation products, xanthan gum, gum arabic, gati gum, native gellan gum, deacylated gellan gum, locust bean gum, tara gum, galactomannan, glucomannan, konjac mannan, curdlan, carrageenans, caraya gum, cassia gum, tamarind seed gum, tragacanth gum, fenugreek gum, psyllium seed gum, succinoglycan, rhamsan gum, alginic acid, sodium alginate, PGA (propylene glycol alginate), soy polysaccharides, methylcellulose, carboxymethylcellulose, hydroxypropylcellulose, hydroxypropylmethylcellulose, agar, fucoidan, porphyrin and laminaran), starches, processed starches (such as ether treated carboxymethyl starch, hydroxypropyl starch, ester treated starch phosphate, sodium starch octenylsuccinate, starch acetate, wet heat-treated starch, acid-treated starch, cross-linking treated starch, alpha-treated starch and non-digestible starch), resistant starches, isomaltulose, polydextrose, indigestible glucans and arabinogalactan; sugar alcohols such as erythritol, sorbitol, xylitol, maltitol, lactitol, reduced isomaltulose and mannitol; and food products containing them (such as maple syrup, agave syrup, etc.). They may be used alone or in combination with two or more species. Among them, in terms of enhancing Maillard reaction of the flavored oil in the heating process to sufficiently impart a meaty flavor and a cooked taste to the flavored oil, preferred is a reducing sugar such as glucose, fructose and xylose among which glucose is particularly preferred.

When a carbohydrate is added thereto, in terms of promoting Maillard reaction of the flavored oil in the heating process to sufficiently impart a meaty flavor and a cooked taste to the flavored oil, an added amount of the carbohydrate may preferably be 0.0010 wt % or more, more preferably 0.0050 wt % or more, even more preferably 0.010 wt % or more, still more preferably 0.050 wt % or more and particularly more preferably 0.10 wt % or more based on the total weight of the flavored oil. No upper limit is particularly set for the added amount of the carbohydrate, but in terms of contribution to the flavor of the flavored oil, an added amount of the carbohydrate may preferably be 10 wt % or less, more preferably 8.0 wt % or less, even more preferably 6.0 wt % or less and still more preferably 4.0 wt % or less based on the total weight of the flavored oil.

Examples of the food item to be contained therein as a further ingredient other than those already listed above include tea leaves, vegetables, fruits, general flavored oils (such as green onion oil, chili oil, huajiao oil, onion oil, garlic oil, ginger oil, mushroom oil, porcini oil, truffle oil, bamboo shoot oil, shiitake mushroom oil, wasabi oil, yuzu citrus oil and burnt soy sauce oil), virgin olive oil and virgin corn oil. Examples of the food additive to be contained therein as a further ingredient include emulsifiers, antioxidants, silicones, pigments, flavoring agents, vitamins other than vitamin B1, and pH adjuster.

The types and amounts of the above-listed food products and food additives can be set appropriately according to, for example, the effects to be achieved. These food products and food additives, when blended into the flavored oil in accordance with the present disclosure, enable it to achieve, for example, the effects of adjusting flavor and color, inhibiting oxidative deterioration, and improving functionality.

In terms of improving shelf life, it is preferred that the moisture content of the flavored oil according to the present disclosure be 5.0 wt % or less, more preferably 3.0 wt. % or less, even more preferably 1.0 wt. % or less, and particularly more preferably 0.5 wt. % or less based on the total weight of the flavored oil. Note that the moisture content of the flavored oil as used herein refers not only to the water blended in the flavored oil, but also to any other moisture content transferred from the raw ingredients other than the water originally blended in the flavored oil. The moisture content of the flavored oil of the present disclosure may be measured by the “Standard methods for the Analysis of Fats and oils and related chemistry, 2.1.3.4-2013, Moisture Content (Karl Fischer Method)”.

### <Manufacturing Method of Flavored Oil>

The flavored oil of the present disclosure is made by adding: (A) one or more ingredients selected from yeast-derived substances and protein hydrolysates; and (B) a spice. The expression that the components (A) and (B) are “added” as used herein does not refer to a process whose sequential order is limited in any way. For example, the components (A) and (B) may be simultaneously added to an oil or fat. Further, a further oil or fat may be added after adding the components (A) and (B) to an oil or fat. Alternatively, the component (A) may be added to an oil or fat while, in an independent manner, the component (B) may be added to another lipid, after which they may be mixed with each other. For example, the component (A) may be added to an oil or fat to which heating, water removal and solids removal may be appropriately performed to make a flavored oil (herein referred to as “flavored oil 1”). Also, the component (B) may be added to another oil or fat to which heating, water removal and solids removal may be appropriately performed to make another flavored oil (herein referred to as “flavored oil 2”). The flavored oils 1 and 2 may then be mixed with each other to make a flavored oil of the present disclosure. When manufacturing a flavored oil according to the present disclosure, the sequence order of the heating, water removal and the solid residue removal (if one or more of these steps are to be performed) in the manufacturing process after adding the components (A) and (B) is not particularly limited in any way. The components (A) and (B) may be added thereto as pure components of the same, or alternatively the components (A) and (B) may be added thereto together with a further component, such as, particularly, water in a manner as described below in any of the flavored oil manufacturing methods 3 to 5. The manner of adding the components may be, for example, in a form of immersion or mixing which is not particularly limited in any way. When a further component other than the components (A) and (B) is added, such component may be added thereto after the heating process as exemplified by the oil-soluble ingredient as shown in the flavored oil manufacturing method 5 described below.

Each of the ingredients may be appropriately agitated using, for example, a stirrer to obtain a flavored oil according to the present disclosure. The mixing order of the ingredients is not particularly limited. When a heating process is performed, the heating is performed in a period after, at least, adding the components (A) and (B). Examples of manufacturing the flavored oil are as shown below.

### (Method 1 of Manufacturing Flavored Oil)

Each of the ingredients is directly added to an oil or fat and then stirred and mixed with each other. The mixture is then subjected to a heating process and then cooled to room temperature.

### (Method 2 of Manufacturing Flavored Oil)

Each of the ingredients is directly added to an oil or fat and then stirred and mixed with each other. The mixture is then subjected to a heating process after which the solid residue and water are removed therefrom. The mixture is then cooled to room temperature.

### (Method 3 of Manufacturing Flavored Oil)

Of all of the ingredients, the oil-soluble ingredients are added to an oil or fat (oil phase portion) and the water-soluble and oil-insoluble ingredients are added to water (aqueous phase portion). The oil phase and aqueous phase portions are mixed and stirred, and the mixture is then subjected to a heating process before being cooled to room temperature.

### (Method 4 of Manufacturing Flavored Oil)

Of all of the ingredients, the oil-soluble ingredients are added to an oil or fat (oil phase portion) and the water-soluble and oil-insoluble ingredients are added to water (aqueous phase portion). The oil phase and aqueous phase portions are mixed and stirred, and the mixture is then subjected to a heating process after which the solid residue and water are removed therefrom. The mixture is then cooled to room temperature.

### (Method 5 of Manufacturing Flavored Oil)

Of all of the ingredients, the water-soluble and oil-insoluble ingredients are added to water (aqueous phase portion). An oil or fat portion (oil phase portion) as being a basic ingredient and the aqueous phase portions are mixed and stirred, and the mixture is subjected to a heating process after which the oil-soluble ingredients are added thereto. The solid residue and water are removed therefrom and the mixture is then cooled to room temperature.

It is preferred, in terms of obtaining a favorable meaty flavor and a cooked taste, that the water-soluble and oil-insoluble ingredients be first added to water and then mixed with an oil or fat. When the water-soluble and oil-insoluble ingredients are added to water, in terms of imparting sufficient flavor to the fat or oil, it is preferred that the weight ratio of water to the water-soluble and oil-insoluble ingredients (water/water-soluble and oil-insoluble ingredients) be 0.001 or more and less than or equal to 100, more preferably 0.005 or more and less than or equal to 50, even more preferably 0.01 or more and less than or equal to 10, still more preferably 0.05 or more and less than or equal to 5, and particularly more preferably 0.1 or more and less than or equal to 1.

In terms of imparting sufficient flavor to the fat and oil, it is preferred that the heating temperature in the heating process be 50° C. or higher, more preferably 70° C. or higher, even more preferably 90° C. or higher, particularly more preferably 100° C. or higher. No upper limit is particularly set for the heating temperature in the heating process, but in terms of preventing an unfavorable flavor such as deterioration odor, a heating temperature in the heating process may preferably be 260° C. or less, more preferably 240° C. or less, even more preferably 220° C. or less, and particularly more preferably 200° C. or less.

A heating period in the heating process may preferably be 1 minute or more, more preferably 10 minutes or more, even more preferably 30 minutes or more, and particularly more preferably 60 minutes or more in terms of imparting a favorable flavor to an oil or fat. No upper limit is particularly set for the heating period in the heating process, but in terms of preventing a burnt odor, a heating period in the heating process may preferably be 240 minutes or less, more preferably 200 minutes or less, and even more preferably 160 minutes or less.

It is preferred in terms of improving the shelf life of the flavored oil that the oil be subjected to a dewatering process. The dewatering process is performed simultaneously with the heating process and/or subsequently to the heating process. Examples of such dewatering process include heat evaporation, centrifugal separation, reduced-pressure heating, reduced-pressure drying, static separation, and dewatering using a hygroscopic agent.

It is preferred in terms of improving the smoothness or handling property of the flavored oil that the solid residue be removed therefrom when manufacturing the flavored oil according to the present disclosure. The removable process of the solid residue is performed after the heating process. Examples of such method for removing the solid residue include, for example, filtration, centrifugation and decantation.

### <Application of Flavored Oil>

The flavored oil according to the present disclosure may be applied to any types of applications which are not particularly limited, and examples of which include a use for a substitute for a conventionally known flavored oil or a use in combination with any types of seasoning (such as conventionally known flavored oils).

The flavored oil according to the present disclosure may be added to any types of food and drink, and may impart a favorable meaty flavor and a cooked taste to the food and drink to which the flavored oil is added. Accordingly, the present disclosure may also provide a food or drink (preferably a meat substitute) to which the flavored oil is added.

Examples of such food and drink to which the flavored oil according to the present disclosure may be added include various types of prepared foods (such as fried foods), confections, baked breads, soups, sauces or other types of food or drink that are made with an oil(s) and/or fat(s). Although the flavored oil of the present disclosure may be used as it is in foods and drinks, the flavored oil may also be added to various types of fats and oils (such as frying oil, margarine, fat spread, shortening, edible oils and fats, oil-in-water emulsions (such as concentrated milk, whipping cream, mayonnaise, etc.), powdered oils and fats, dressings) after which they may be used as ingredients in food and drink products.

In terms of sufficiently imparting a meaty flavor and a cooked taste to a food and drink product, an added amount of the flavored oil according to the present disclosure to a food or drink may preferably be 0.10 wt % or more, more preferably 0.50 wt % or more, even more preferably 1.0 wt % or more, still more preferably 3.0 wt % or more and particularly preferably 5.0 wt % or more based on the total weight of the food or drink. Although no upper limit is particularly set for the added amount of the flavored oil to a food or drink, an added amount of the flavored oil to a food or drink may preferably be 40 wt % or less, more preferably 35 wt % or less, even more preferably 30 wt % or less, still more preferably 25 wt % or less, and particularly more preferably 20 wt % or less based on the total weight of the food and drink.

The present disclosure is advantageous in that it imparts a meaty flavor and cooked taste without containing any animal-based ingredient. Accordingly, the embodiments of the present disclosure allow a food product to have a favorable meaty flavor and a cooked taste even when no animal-based oil or fat (such as an animal meat) or food additive (e.g., an animal-based ingredient such as an animal-based extract) is contained therein. Further, the present disclosure is advantageous in that it imparts a favorable sweetness to meat substitutes, sauces (such as pasta sauces and curry sauces) and seasonings, which therefore allows the reduction of an unappetizing odor issuing from the ingredients (such as the green-beany odor of soybean products).

The term “meat substitutes” as used herein encompasses any food products that are made from plant-based ingredients, as being main ingredients, which include beans (such as soybeans, peas, chickpeas and fava beans), rice or any other grains. It is preferred in terms of readily imparting advantageous effects of the present disclosure that the meat substitute according to the present disclosure contain no animal-based ingredient (such as animal meat, animal meat-based ingredient, animal fat, milk constituent and egg).

Examples of such meat substitute include Tofu hamburger patties and plant protein processed foods (such as a hamburger-patty-analog food product, a dumpling-analog food product (such as a food product analogous to Jiaozi or Siu Mai), a food product analogous to steamed stuffed bun, a food product analogous to fillet meat (such as grilled meat or stir-fried food), pasta sauces and Keema Currey).

### EXAMPLES

Hereinafter, the present disclosure will be described in more detail by means of examples; however, the present disclosure is not limited to these examples. The formulations in the tables indicate mass percentages. The numerals allocated to the manufacturing method in Tables 1A, 1B and 2 correspond to the identification numbers thereof as shown in the subheads for the methods of manufacturing flavored oil.

### <Test 1: Preparation and Evaluation of Flavored Oil>

flavored oils were respectively prepared by the methods explained below, and then the oils were evaluated.

### (Flavored Oil Preparation)

flavored oils were prepared by the methods explained below.

### Step 1

Of the ingredients listed in Tables 1A, 1B and 2, (A1) yeast-derived substances and/or (A2) protein hydrolysates, (B) spices, and vitamin B1 were added to rapeseed oil after being dispersed in water if used. In example 13, the ingredients were directly added to the rapeseed oil.

### Step 2

The mixture was heated whilst being stirred in accordance with the conditions as outlined in Tables 1A, 1B and 2.

### Step 3

Optionally, a nut derivative and/or a smoked oil as shown in Tables 1A, 1B and 2, if used, was added to the resultant product obtained in Step 2.

### Step 4

The product obtained in Step 2 or 3 was filtrated to remove the solid residue and water.

### Step 5

The flavored oil obtained in Step 4 was cooled to room temperature and subjected to the tests as explained below.

### (Flavored Oil Evaluation)

Each of the flavored oils was subjected to the sensory evaluation for meaty flavor, cooked taste, roasted flavor, robustness and sweetness based on the criteria as explained below.

The sensory evaluations were carried out by the panels selected in a way as explained below. Panel candidates were given a flavor discrimination test for the five primary tastes (bitter, salty, sour, sweet and umami), a taste intensity difference discrimination test, a taste discrimination test for food item, and a standard smell test to select ten people as the panels who were determined as suitable in all of these tests. To carry out the evaluation, the whole panels had a discussion to get alignment on the characteristics of each evaluation item to ensure that the whole panel have a common understanding on the criteria. In order to eliminate the bias of the panels in the sensory evaluation and to improve the accuracy of the evaluation, the test section ID numbers and contents of the samples were not informed to the panel, and the samples were randomly presented.

### [Sensory Evaluation]

flavored oils as outlined in Tables 1A and 1B were subjected to the sensory evaluations by the ten panels to evaluate the perceived intensities of the “meaty flavor”, “cooked taste”, “roasted flavor”, “robustness” and “sweetness” during the tasting on the basis of the score levels of 1 to 10, where the score level of 1 is a score of a reference example (hereafter referred to as “reference example 1”) and the score level of 10 is a score of a grilled patty of 100% pure beef, and the respective average scores were determined. As to the “meaty flavor” and the “cooked taste”, the score determined as “o” or greater (score of 3 or more) received a passing grade. As to the “roasted flavor” and “robustness”, the score determined as “Δ” or greater (score of 3 or more) received a passing grade. The results are as shown at the section of “Evaluation” in Tables 1A and 1B.

### Evaluation Criteria for Meaty Flavor:

⊚++: An average score is 7 or more
⊚+: An average score is 6 or more and less than 7
⊚: An average score is 4 or more and less than 6
◯: An average score is 3 or more and less than 4
x: An average score is less than 3

### Evaluation Criteria for Cooked Taste:

⊚++: An average score is 7 or more
⊚+: An average score is 6 or more and less than 7
⊚: An average score is 4 or more and less than 6
◯: An average score is 3 or more and less than 4
x: An average score is less than 3

### Evaluation Criteria for Roasted Flavor:

⊚+: An average score is 7 or more
⊚: An average score is 6 or more and less than 7
◯: An average score is 4 or more and less than 6
Δ: An average score is 3 or more and less than 4
x: An average score is less than 3

### Evaluation Criteria for Robustness:

⊚+: An average score is 7 or more
⊚: An average score is 6 or more and less than 7
◯: An average score is 4 or more and less than 6
Δ: An average score is 3 or more and less than 4
x: An average score is less than 3

TABLE 1A

| | | Working | Working | Working | Working | Working | Working | Working | Working | Working | Working |
|---|---|---|---|---|---|---|---|---|---|---|---|
| | | example | example | example | example | example | example | example | example | example | example |
| | | 1 | 2 | 3 | 4 | 5 | 6 | 7 | 8 | 9 | 10 |
| (A1) Yeast- | Beer yeast | 3 | | | | | | | | | |
| derived | digest | | | | | | | | | | |
| substance | Torula yeast | | 3 | | | 3 | 3 | 3 | 2 | 3 | 3 |
| | extract | | | | | | | | | | |
| (A2) Protein | Corn-derived | | | 3 | | | | 3 | 4 | 3 | 3 |
| hydrolysate | protein | | | | | | | | | | |
| | hydrolysate | | | | | | | | | | |
| | Soy-derived | | | | 3 | | | | | | |
| | protein | | | | | | | | | | |
| | hydrolysate | | | | | | | | | | |
| (B) Spice | Clove | | | | | 0.2 | | | | | |
| | Nutmeg | 0.2 | 0.2 | 0.2 | 0.2 | | | 0.2 | 0.2 | 0.2 | 0.2 |
| | Allspice | | | | | | 0.2 | | | | |
| Vitamin B₁ | | | | | | | | | | 0.2 | 0.2 |
| Water | | 3 | 3 | 3 | 3 | 3 | 3 | 5 | 5 | 5 | 5 |
| Rapeseed oil | | 93.8 | 93.8 | 93.8 | 93.8 | 93.8 | 93.8 | 88.8 | 88.8 | 88.6 | 88.6 |
| Heating | Heating | 120 | 120 | 120 | 120 | 120 | 120 | 120 | 120 | 120 | 90 |
| condition | temperature | | | | | | | | | | |
| | (° C.) | | | | | | | | | | |
| | Heating | 2.5 | 2.5 | 2.5 | 2.5 | 2.5 | 2.5 | 2.5 | 2.5 | 2.5 | 10 |
| | period (h) | | | | | | | | | | |
| Manufacturing method | | Method 4 | | | | | | | | | |
| Evaluation | Meaty flavor | ◯ | ⊚ | ⊚ | ◯ | ⊚ | ⊚ | ⊚+ | ⊚+ | ⊚++ | ⊚+ |
| | Cooked taste | ⊚ | ⊚ | ⊚ | ⊚ | ◯ | ◯ | ⊚+ | ⊚+ | ⊚++ | ⊚+ |
| | Roasted flavor | Δ | ◯ | ◯ | ◯ | ◯ | ◯ | ⊚ | ⊚ | ⊚ | Δ |
| | Robustness | Δ | Δ | Δ | Δ | Δ | Δ | ◯ | ◯ | ◯ | ◯ |

TABLE 1B

| | | Working | Working | Working | Comparative | Comparative | Comparative | Reference |
|---|---|---|---|---|---|---|---|---|
| | | example | example | example | example | example | example | example |
| | | 11 | 12 | 13 | 1 | 2 | 3 | 1 |
| (A1) Yeast-derived | Beer yeast digest | | | | | | | |
| substance | Torula yeast extract | 3 | 3 | 3 | 3 | | | |
| (A2) Protein hydrolysate | Corn-derived protein | 3 | 3 | 3 | | 3 | | |
| | hydrolysate | | | | | | | |
| | Soy-derived protein | | | | | | | |
| | hydrolysate | | | | | | | |
| (B) Spice | Clove | | | | | | | |
| | Nutmeg | 0.2 | 0.2 | 0.2 | | | 0.2 | |
| | allspice | | | | | | | |
| Vitamin B₁ | | 0.2 | 0.2 | 0.2 | | | | |
| Water | | 5 | 15 | | 3 | 3 | 3 | 3 |
| Rapeseed oil | | 88.6 | 78.6 | 93.6 | 94 | 94 | 96.8 | 97 |
| Heating condition | Heating temperature | 160 | 120 | 120 | 120 | 120 | 120 | 120 |
| | (° C.) | | | | | | | |
| | Heating period (h) | 1 | 2.5 | 2.5 | 2.5 | 2.5 | 2.5 | 2.5 |
| Manufacturing method | | Method 4 | | Method 2 | Method 4 | | | Method 2 |
| Evaluation | Meaty flavor | ⊚+ | ⊚+ | ⊚+ | ◯ | ◯ | X | — |
| | Cooked taste | ⊚+ | ⊚+ | ⊚+ | X | X | X | — |
| | Roasted flavor | ⊚+ | ◯ | ⊚+ | Δ | Δ | X | — |
| | Robustness | ◯ | ◯ | ◯ | X | X | X | — |

### [Sensory Evaluation]

Flavored oils as outlined in Table 2 were subjected to the sensory evaluations by the ten panels to evaluate the perceived intensities of the “meaty flavor”, “cooked taste”, “roasted flavor”, “robustness” and “sweetness” during the tasting on the basis of the score levels of 1 to 5, where the score level of 1 is a score of working example 9 and the score level of 5 is a score of a grilled patty of 100% pure beef, and the respective average scores were determined. The results are as shown at the section of “Evaluation” in Table 2.

### Evaluation Criteria for Meaty Flavor:

⊚+: An average score is 3.5 or more
⊚: An average score is 2.0 or more and less than 3.5
◯: An average score is 1.0 or more and less than 2.0

### Evaluation Criteria for Cooked Taste:

⊚+: An average score is 3.5 or more
⊚: An average score is 2.0 or more and less than 3.5
◯: An average score is 1.0 or more and less than 2.0

### Evaluation Criteria for Roasted Flavor:

⊚+: An average score is 3.5 or more
⊚: An average score is 2.0 or more and less than 3.5
◯: An average score is 1.0 or more and less than 2.0

### Evaluation Criteria for Robustness:

⊚+: An average score is 3.5 or more
⊚: An average score is 2.0 or more and less than 3.5
◯: An average score is 1.0 or more and less than 2.0

### Evaluation Criteria for Sweetness:

⊚+: An average score is 3.5 or more
⊚: An average score is 2.0 or more and less than 3.5
◯: An average score is 1.0 or more and less than 2.0

TABLE 2

| | | Working | Working | Working | Working |
|---|---|---|---|---|---|
| | | example | example | example | example |
| | | 14 | 15 | 16 | 17 |
| (A1) Yeast-derived | Beer yeast digest | | | | |
| substance | Torula yeast extract | 3 | 3 | 3 | 3 |
| (A2) Protein hydrolysate | Corn-derived protein | 3 | 3 | 3 | 3 |
| | hydrolysate | | | | |
| | Soy-derived protein | | | | |
| | hydrolysate | | | | |
| (B) Spice | Clove | | | | |
| | Nutmeg | 0.2 | 0.2 | 0.2 | 0.2 |
| | allspice | | | | |
| Vitamin B₁ | | 0.2 | 0.2 | 0.2 | 0.2 |
| Nut derivative | hazelnut oil | 5 | | | |
| | Almond oil | | 5 | | |
| | Coconut oil | | | 5 | 5 |
| Smoke oil | | | | | 3 |
| Water | | 5 | 5 | 5 | 5 |
| Rapeseed oil | | 83.6 | 83.6 | 83.6 | 80.6 |
| Heating condition | Heating temperature | 120 | 120 | 120 | 120 |
| | (° C.) | | | | |
| | Heating period (h) | 2.5 | 2.5 | 2.5 | 2.5 |
| Manufacturing method | | Method 5 | | | |
| Evaluation | Meaty flavor | ◯ | ◯ | ◯ | ⊚ |
| | Cooked taste | ⊚ | ⊚ | ⊚ | ⊚+ |
| | Roasted flavor | ⊚ | ⊚ | ⊚ | ⊚+ |
| | Robustness | ⊚+ | ⊚+ | ⊚+ | ⊚+ |
| | Sweetness | ⊚ | ⊚ | ⊚+ | ⊚+ |

### <Test 2: Preparation and Evaluation of Soyburger Patty>

20 wt % of flavored oil selected from any one of working example 17, comparative example 1 or rapeseed oil, and 80 wt % of palm oil were mixed together to prepare an adjusted flavored oil for soyburger patty. The formulations are as shown in Table 3. 40 g of powdered soy protein, 8 g of methylcellulose, and 40 g of rapeseed oil were mixed, to which 312 g of ice water was added and thoroughly beaten with a cutter mixer to make a soybean curd. Next, 72 g of granular soy protein was rehydrated with 144 g of water, to which were added 219 g of soybean curd, 100 g of the adjusted flavored oil, 60 g of sauteed onion, 4 g of salt, and 1 g of spice, and was kneaded well until it became sticky to make the dough. The dough was formed into respective 50 g portions, which were baked for 15 minutes in a convection oven at 180° C. After the baking, each portion was cut in half to subject them to the examination.

### [Sensory Evaluation]

The prepared soyburger patties were subjected to the sensory evaluations by the ten panels to evaluate the perceived intensities of the “meaty flavor”, “cooked taste”, “roasted flavor”, “robustness”, “sweetness” and “beany odor masking effect” during the tasting on the basis of a reference example (herein referred to as “reference example 2”) obtained by mixing 20 wt % of rapeseed oil and 80 wt % of palm oil to determine the number of people who perceived more intensified sensory stimulus (or less intensified sensory stimulus for the sensory item of “beany odor masking effect”) than the reference example for each of the sensory items. The score determined as “A” or greater received a passing grade in each of the items. The results are as shown in Table 3.

### Evaluation Criteria for Meaty Flavor:

⊚: Among the 10 panels, 9 or more panels responded that they felt more intensified sensory stimulus than the reference example.
◯: Among the 10 panels, panels of 7 or more and less than or equal to 8 people responded that they felt more intensified sensory stimulus than the reference example.
Δ: Among the 10 panels, panels of 5 or more and less than or equal to 6 people responded that they felt more intensified sensory stimulus than the reference example.
x: Among the 10 panels, panels of less than or equal to 4 people responded that they felt more intensified sensory stimulus than the reference example.

### Evaluation Criteria for Roasted Flavor:

⊚: Among the 10 panels, 9 or more panels responded that they felt more intensified sensory stimulus than the reference example.
◯: Among the 10 panels, panels of 7 or more and less than or equal to 8 people responded that they felt more intensified sensory stimulus than the reference example.
Δ: Among the 10 panels, panels of 5 or more and less than or equal to 6 people responded that they felt more intensified sensory stimulus than the reference example.
x: Among the 10 panels, panels of less than or equal to 4 people responded that they felt more intensified sensory stimulus than the reference example.

### Evaluation Criteria for Robustness:

⊚: Among the 10 panels, 9 or more panels responded that they felt more intensified sensory stimulus than the reference example.
◯: Among the 10 panels, panels of 7 or more and less than or equal to 8 people responded that they felt more intensified sensory stimulus than the reference example.
Δ: Among the 10 panels, panels of 5 or more and less than or equal to 6 people responded that they felt more intensified sensory stimulus than the reference example.
x: Among the 10 panels, panels of less than or equal to 4 people responded that they felt more intensified sensory stimulus than the reference example.

### Evaluation Criteria for Sweetness:

⊚: Among the 10 panels, 9 or more panels responded that they felt more intensified sensory stimulus than the reference example.
◯: Among the 10 panels, panels of 7 or more and less than or equal to 8 people responded that they felt more intensified sensory stimulus than the reference example.
Δ: Among the 10 panels, panels of 5 or more and less than or equal to 6 people responded that they felt more intensified sensory stimulus than the reference example.
x: Among the 10 panels, panels of less than or equal to 4 people responded that they felt more intensified sensory stimulus than the reference example.

### Evaluation Criteria for Masking Beany Odor:

⊚: Among the 10 panels, 9 or more panels responded that they felt weaker beany odor than the reference example.
◯: Among the 10 panels, panels of 7 or more and less than or equal to 8 people responded that they felt weaker beany odor than the reference example.
Δ: Among the 10 panels, panels of 5 or more and less than or equal to 6 people responded that felt weaker beany odor than the reference example.
x: Among the 10 panels, panels of less than or equal to 4 people responded that they felt weaker beany odor than the reference example.

TABLE 3

| | | Working | Comparative | Reference |
|---|---|---|---|---|
| | | example | example | example |
| | | 18 | 4 | 2 |
| Adjusted | Flavor oil of working | 20 | | |
| flavored | example 17 | | | |
| oil for | Flavor oil of | | 20 | |
| soyburger | comparative | | | |
| patty | example 1 | | | |
| | Rapeseed oil | | | 20 |
| | Palm oil | 80 | 80 | 80 |
| Evaluation | Meaty flavor | ⊚ | X | — |
| | Roasted flavor | ⊚ | X | — |
| | Robustness | ⊚ | X | — |
| | Sweetness | ⊚ | X | — |
| | Beany odor masking | ⊚ | X | — |
| | effect | | | |

### <Test 3: Preparation and Evaluation of Curry>

20 wt % of flavored oil selected from any one of working example 17 or comparative example 1, and 80 wt % of rapeseed oil were mixed together to prepare an adjusted flavored oil for curry. As a reference example, 100 wt % pure rapeseed oil was used as a flavored oil for curry (herein referred to as “reference example 3”). The formulations are as shown in Table 4. 2 wt % of the adjusted flavored oil for curry was added to a vegetable curry that is commercially available, which was subjected to the examination.

### [Sensory Evaluation]

The prepared curries were subjected to the sensory evaluations by the ten panels to evaluate the perceived intensities of the “meaty flavor”, “roasted flavor”, “robustness” and “sweetness” during the tasting on the basis of the pure rapeseed oil (reference example 3) to determine the number of people who perceived more intensified sensory stimulus than the reference example 3 for each of the sensory items. The score determined as “A” or greater received a passing grade in each of the items. Each of the curries was subjected to the evaluation with respect to the perceived intensities of meaty flavor, roasted flavor, robustness and sweetness during the tasting. The results are as shown in Table 4.

### Evaluation Criteria for Meaty Flavor:

⊚: Among the 10 panels, 9 or more panels responded that they felt more intensified sensory stimulus than the reference example.
◯: Among the 10 panels, panels of 7 or more and less than or equal to 8 people responded that they felt more intensified sensory stimulus than the reference example.
Δ: Among the 10 panels, panels of 5 or more and less than or equal to 6 people responded that they felt more intensified sensory stimulus than the reference example.
x: Among the 10 panels, panels of less than or equal to 4 people responded that they felt more intensified sensory stimulus than the reference example.

### Evaluation Criteria for Roasted Flavor:

⊚: Among the 10 panels, 9 or more panels responded that they felt more intensified sensory stimulus than the reference example.
◯: Among the 10 panels, panels of 7 or more and less than or equal to 8 people responded that they felt more intensified sensory stimulus than the reference example.
Δ: Among the 10 panels, panels of 5 or more and less than or equal to 6 people responded that they felt more intensified sensory stimulus than the reference example.
x: Among the 10 panels, panels of less than or equal to 4 people responded that they felt more intensified sensory stimulus than the reference example.

### Evaluation Criteria for Robustness:

⊚: Among the 10 panels, 9 or more panels responded that they felt more intensified sensory stimulus than the reference example.
◯: Among the 10 panels, panels of 7 or more and less than or equal to 8 people responded that they felt more intensified sensory stimulus than the reference example.
Δ: Among the 10 panels, panels of 5 or more and less than or equal to 6 people responded that they felt more intensified sensory stimulus than the reference example.
x: Among the 10 panels, panels of less than or equal to 4 people responded that they felt more intensified sensory stimulus than the reference example.

### Evaluation Criteria for Sweetness:

⊚: Among the 10 panels, 9 or more panels responded that they felt more intensified sensory stimulus than the reference example.
◯: Among the 10 panels, panels of 7 or more and less than or equal to 8 people responded that they felt more intensified sensory stimulus than the reference example.
Δ: Among the 10 panels, panels of 5 or more and less than or equal to 6 people responded that they felt more intensified sensory stimulus than the reference example.
x: Among the 10 panels, panels of less than or equal to 4 people responded that they felt more intensified sensory stimulus than the reference example.

TABLE 4

| | | Working | Comparative | Reference |
|---|---|---|---|---|
| | | example | example | example |
| | | 19 | 5 | 3 |
| Adjusted | Flavor oil of | 20 | | |
| flavored | working | | | |
| oil for | example 17 | | | |
| curry | Flavor oil of | | 20 | |
| | comparative example 1 | | | |
| | Rapeseed oil | 80 | 80 | 100 |
| Evaluation | Meaty flavor | ◯ | X | — |
| | Roasted flavor | ⊚ | X | — |
| | Robustness | ⊚ | X | — |
| | Sweetness | ◯ | X | — |

### <Test 4: Preparation and Evaluation of Grilled Soy Meat>

20 wt % of flavored oil selected from any one of working example 17 or comparative example 1, and 80 wt % of palm oil were mixed together to prepare an adjusted flavored oil for grilled soy meat, so-called plant-based Korean barbecue or yakiniku. As a reference example, 100 wt % pure rapeseed oil was used as a flavored oil for the grilled soy meat (herein referred to as “reference example 4”). The formulations are as shown in Table 5. A fillet-type tissue soy protein was heated in boiling hot water and rehydrated. 20 g of the adjusted flavored oil for grilled soy meat was put in a pan, and 100 g of the rehydrated soy protein was sauteed. Soy sauce, Sake and Mirin (sweet cooking rice wine) were mixed to make a sauce, and 30 g of this sauce was put into the pan and then heated until all of the excess water was boiled off. The obtained product was subjected to the examination.

### [Sensory Evaluation]

The prepared grilled soy meats were subjected to the sensory evaluations by the ten panels to evaluate the perceived intensities of the “meaty flavor”, “cooked taste”, “roasted flavor”, “robustness”, “sweetness” and “beany odor masking effect” during the tasting on the basis of a pure rapeseed oil (reference example 4) to determine the number of people who perceived more intensified sensory stimulus than the reference example for each of the sensory items. The score determined as “A” or greater received a passing grade in each of the items. The results are as shown in Table 5.

### Evaluation Criteria for Meaty Flavor:

⊚: Among the 10 panels, 9 or more panels responded that they felt more intensified sensory stimulus than the reference example.
◯: Among the 10 panels, panels of 7 or more and less than or equal to 8 people responded that they felt more intensified sensory stimulus than the reference example.
Δ: Among the 10 panels, panels of 5 or more and less than or equal to 6 people responded that they felt more intensified sensory stimulus than the reference example.
x: Among the 10 panels, panels of less than or equal to 4 people responded that they felt more intensified sensory stimulus than the reference example.

### Evaluation Criteria for Roasted Flavor:

⊚: Among the 10 panels, 9 or more panels responded that they felt more intensified sensory stimulus than the reference example.
◯: Among the 10 panels, panels of 7 or more and less than or equal to 8 people responded that they felt more intensified sensory stimulus than the reference example.
Δ: Among the 10 panels, panels of 5 or more and less than or equal to 6 people responded that they felt more intensified sensory stimulus than the reference example.
x: Among the 10 panels, panels of less than or equal to 4 people responded that they felt more intensified sensory stimulus than the reference example.

### Evaluation Criteria for Robustness:

⊚: Among the 10 panels, 9 or more panels responded that they felt more intensified sensory stimulus than the reference example.
◯: Among the 10 panels, panels of 7 or more and less than or equal to 8 people responded that they felt more intensified sensory stimulus than the reference example.
Δ: Among the 10 panels, panels of 5 or more and less than or equal to 6 people responded that they felt more intensified sensory stimulus than the reference example.
x: Among the 10 panels, panels of less than or equal to 4 people responded that they felt more intensified sensory stimulus than the reference example.

### Evaluation Criteria for Sweetness:

⊚: Among the 10 panels, 9 or more panels responded that they felt more intensified sensory stimulus than the reference example.
◯: Among the 10 panels, panels of 7 or more and less than or equal to 8 people responded that they felt more intensified sensory stimulus than the reference example.
Δ: Among the 10 panels, panels of 5 or more and less than or equal to 6 people responded that they felt more intensified sensory stimulus than the reference example.
x: Among the 10 panels, panels of less than or equal to 4 people responded that they felt more intensified sensory stimulus than the reference example.

### Evaluation Criteria for Masking Beany Odor:

⊚: Among the 10 panels, 9 or more panels responded that they felt weaker beany odor than the reference example.
◯: Among the 10 panels, panels of 7 or more and less than or equal to 8 people responded that they felt weaker beany odor than the reference example.
Δ: Among the 10 panels, panels of 5 or more and less than or equal to 6 people responded that felt weaker beany odor than the reference example.
x: Among the 10 panels, panels of less than or equal to 4 people responded that they felt weaker beany odor than the reference example.

TABLE 5

| | | Working | Comparative | Reference |
|---|---|---|---|---|
| | | example | example | example |
| | | 20 | 6 | 4 |
| Adjusted | Flavor oil of working | 20 | | |
| flavored | example 17 | | | |
| oil for | Flavor oil of | | 20 | |
| grilled | comparative example 1 | | | |
| soy meat | Palm oil | 80 | 80 | |
| | Rapeseed oil | | | 100 |
| Evaluation | Meaty flavor | ⊚ | X | — |
| | Roasted flavor | ⊚ | X | — |
| | Robustness | ⊚ | X | — |
| | Sweetness | ⊚ | X | — |
| | Beany odor masking | ⊚ | X | — |
| | effect | | | |

What is claimed is:

1. A flavored oil comprising:
A) one or more ingredients selected from yeast-derived substances and protein hydrolysates;
B) a spice; and
C) an oil or fat.

2. The flavored oil according to claim 1, wherein the flavored oil comprises both of the yeast-derived substance and the protein hydrolysate.

3. The flavored oil according to claim 2, wherein a weight ratio of the yeast-derived substance to the protein hydrolysate is 0.01 or more and 10 or less.

4. The flavored oil according to claim 3, wherein the ratio of the yeast-derived substance to the protein hydrolysate is 0.3 or more and 2 or less.

5. The flavored oil according to claim 1, wherein the flavored oil comprises a yeast extract of the yeasts selected from baker's yeasts, beer yeasts, sake yeasts, wine yeasts, soy sauce yeasts and torula yeast.

6. The flavored oil according to claim 5, wherein the yeast extract is of torula yeast.

7. The flavored oil according to claim 1, wherein the flavored oil further comprises vitamin B1.

8. The flavored oil according to claim 1, wherein the spice is derived from one or more plants selected from the species consisting of Myristicaceae and Myrtaceae.

9. The flavored oil according to claim 1, wherein the flavored oil further comprises a nut derivative.

10. The flavored oil according to claim 9, wherein an amount of the nut derivative is or more and 15 wt % or less based on the total weight of the flavored oil.

11. A food or drink product comprising the flavored oil according to claim 1.

12. A method for manufacturing the flavored oil according to claim 1, comprising the steps of:
A) adding the one or more ingredients selected from yeast-derived substances and protein hydrolysate, and the spice to the oil or fat to prepare a mixture;
B) heating the mixture prepared in step A) whilst stirring the same; and
C) cooling the product obtained in step B) to room temperature.

13. The method according to claim 12, further comprising a step of D) filtrating the product obtained after step B) to remove a solid residue(s) and water.

14. The method according to claim 12, further comprising a step of E) adding vitamin B1.

15. The method according to claim 14, wherein, in step E), the added amount of vitamin B1 is 0.0010 wt % or more and 5.0 wt % or less based on the total weight of the flavored oil.

16. The method according to claim 12, wherein the method comprises in step A) the steps of:
A1) allowing an oil-soluble ingredient(s) of the mixture to be added to the oil or fat to obtain an oil phase portion;
A2) allowing a water-soluble/oil-insoluble ingredient(s) of the mixture to be added to water to obtain an aqueous phase portion; and
A3) mixing and stirring the oil phase portion and the aqueous phase portion.

17. The method according to claim 13, wherein the method comprises in step A) the steps of:
A1) allowing an oil-soluble ingredient(s) of the mixture to be added to the oil or fat to obtain an oil phase portion;
A2) allowing a water-soluble/oil-insoluble ingredient(s) of the mixture to be added to water to obtain an aqueous phase portion; and
A3) mixing and stirring the oil phase portion and the aqueous phase portion.
